(19) United States
(12) Patent Application Publication
(10) Pub. No.: US 2006/0268895 A1
(43) Pub. Date: Nov. 30, 2006

(54) Linking a mobile wireless communication device to a proximal consumer broadcast device

(76) Inventor: Michael D. Kotzin, Buffalo Grove, IL (US)

Correspondence Address: MOTOROLA INC, 600 NORTH US HIGHWAY 45, ROOM AS437, LIBERTYVILLE, IL, 60048-5343, US

(21) Appl. No.: 11/130,920

(22) Filed: May 17, 2005

(51) Int. Cl. H04L 12/56

(52) U.S. Cl. 370/395.64

(57) ABSTRACT

A portable wireless communication device (200) including a user interface (230), a receiving device (240/250) for receiving information from a proximal broadcast information receiving device, and a processor (220) programmed to identify the information received from the proximal broadcast information receiving device. The identification may be made by a signature and/or correlation analysis. In another embodiment, the information received from the proximal broadcast information receiving device is sent to a server which identifies the information received from the proximal broadcast information receiving device.

### FIELD OF THE DISCLOSURE

The present disclosure relates generally to wireless communications, and more particularly to communicating between a wireless communication device, for example, a cellular telephone or a wirelessly enabled portable computing device, and a proximal consumer broadcast signal reception device like a television, wireless devices and corresponding methods.

### BACKGROUND OF THE DISCLOSURE

In some consumer broadcast signal reception devices, for example, television sets, supplemental and/or non-programming information is often displayed, usually momentarily, on the viewing screen when the device is first powered ON or when the channel is first selected and/or changed, for example, while channel surfing. Many devices also enable the user to display supplemental or non-programming information at any time on command, for example, by pressing a “display” key on a television control panel. In some cases, this information may be shown only momentarily if it obstructs programming displayed on the viewing screen. In other cases, this information is displayed permanently or temporarily as a watermark, which is at least partially transparent.

The supplemental or non-programming information may be program specific or it may be related to the broadcast reception device, for example, its operating mode or configuration. Some information, for example, broadcast station identification, which is broadcast periodically, may be required by governmental regulatory agencies like the Federal Communications Commission in the United States. Other exemplary information includes channel number, network and/or local affiliate identification or call sign information, programming information, broadcast format information (e.g., HDTV, NTSC), audio information (e.g., mono or stereo mode), audio information (e.g., surround or non-surround sound audio mode), display aspect ratio information (e.g., standard, wide screen, etc.), volume settings, among other information.

It is also known to interact with broadcast programming using a personal computer. For example, the American Broadcasting Company (ABC) Enhanced TV service is a live interactive television experience that allows television viewers to interact with broadcast programming using an Internet browser on a computer equipped with a television tuner. The view must be able to view both the television programming and the Internet Browser application simultaneously. The ABC Enhanced TV services provide in-depth broadcast program information and allow real-time viewer interaction with the broadcast programming including participation in play-along games, polls and other activities.

The various aspects, features and advantages of the disclosure will become more fully apparent to those having ordinary skill in the art upon careful consideration of the following Detailed Description thereof with the accompanying drawings described below.

### BRIEF DESCRIPTION OF THE DRAWINGS

FIG. 1 illustrates a wireless communication device receiving information from a broadcast signal receiving device.

FIG. 2 is a block diagram of a wired or wireless communication device capable of receiving information from a broadcast signal receiving device.

FIG. 3 illustrates a communication device that presents the channel and network identification.

FIG. 4 illustrates receiving and displaying supplemental program information received from a broadcast signal receiving device.

FIG. 5 illustrates modifying the display of program information received from a broadcast signal receiving device.

FIG. 6 is an exemplary communication system.

### DETAILED DESCRIPTION

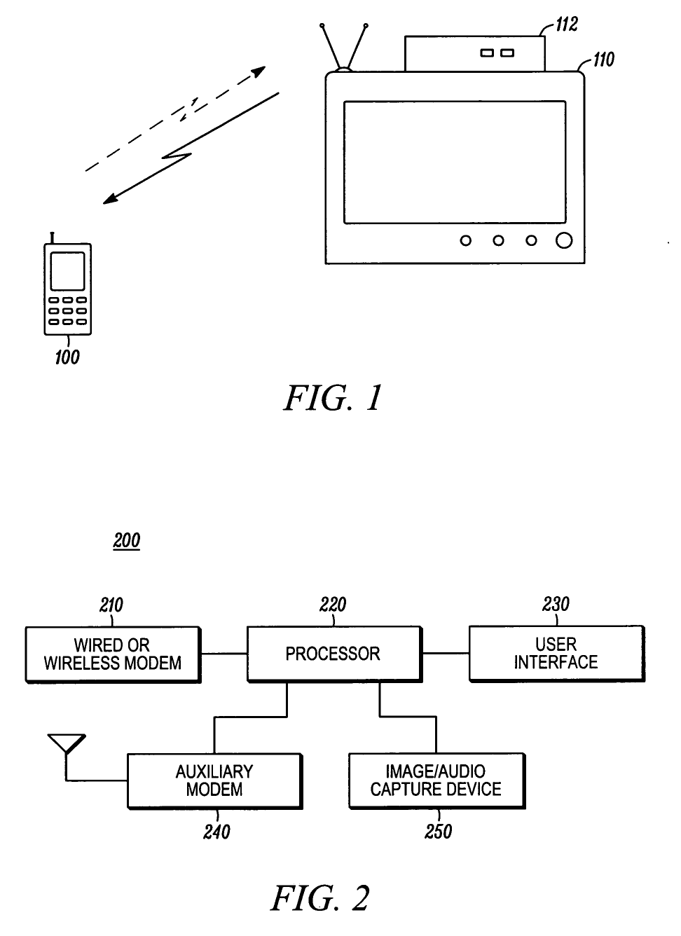

In FIG. 1 a wireless communication device 100 receives information from a broadcast signal receiving device 110 located proximally to the wireless device. For example, the communication device may communicate with a cable set top box or other device 112 associated with the device 110. The range between the wireless communication device and the broadcast signal receiving device is “proximal” when the wireless communication device is capable of receiving information from the broadcast signal receiving device. In some applications, the user of the device 100 must be within visual range of the broadcast signal receiving device 110, although in other applications it is not necessary for the user to be within visual or audio range of the broadcast signal receiving device.

In FIG. 1, the wireless communication device is embodied as a mobile cellular telephone handset. In other embodiments, the device may be some other wirelessly enabled mobile communications device, for example, a personal digital assistant (PDA) or a wirelessly enabled computing device, or a wirelessly enabled camera or other consumer device. In still other embodiments, a hardwired device, for example, a personal computer (PC) or an Internet browsing device receives information from the broadcast signal receiving device.

FIG. 2 is an exemplary wired or wireless communication device 200 capable of receiving information from the broadcast signal receiving device comprises, among other components, a transceiver or modem 210 for communicating with other entities over a wired or wireless communication network, as discussed further below. The modem could be a cellular communications protocol compliant modem, a cable or DSL modem or some other modem. The transceiver 210 is coupled to a processor 220, which may be embodied as controller and/or a digital signal processor (DSP), which is communicably coupled to memory by various busses, which are not shown but are known by those of ordinary skill in the art. The exemplary device 200 also includes user interfaces 230, for example, a display, input devices, audio outputs, etc., coupled to the processor. In some embodiments, the communication device also includes a device, for example, a TV receiver, DVB receiver, or an alternative information communication broadcast, e.g., cellular broadcast, for receiving broadcast signals directly.

In some embodiments, the communications device includes a wireless receiver capable of receiving information from the broadcast signal receiving device, and the broadcast signal receiving device includes a transmitter capable of transmitting signals that may be received by the communication device receiver. In FIG. 1, the broadcast signal receiving device 110 transmits information to the communication device 100. In one embodiment, the supplemental or non-programming information is transmitted in a point-to-multipoint (broadcast) mode by the broadcast signal receiving device 110 such that it may be received by more than one communication device. In other applications, the information is transmitted in a point-to-point mode such that it is addressed to a specific recipient device.

In FIG. 2, the communications device 200 includes an auxiliary wireless modem 240 including a receiver capable of receiving information from the broadcast signal receiving device. In some embodiments, the wireless modem 240 may be a receiver only device. In some embodiments, communication device includes a transmitter, and the broadcast signal receiving device includes a receiver for receiving communications from the communication device. Exemplary modems suitable for this application include Bluetooth transceivers, infrared, for example, IrDA transceivers, WLANs such as 802.11 and other wireless transceivers operating pursuant to an open or proprietary wireless communication protocol.

In embodiments where the broadcast signal receiving device transmits information for reception by one or more communication devices, the broadcast signal receiving device may transmit a variety of programming and non-programming related information to the communication device. This information may be transmitted periodically or it may be transmitted on request. For example, in embodiments where the communication device includes an auxiliary transmitter, for example, the modem 240 in FIG. 2, the communication device may transmit a request for information from the broadcast signal receiving device, which request prompts the transmission of information from the broadcast signal receiving device. In other embodiments, the information is transmitted when the broadcast signal receiving device detects the presence of the communication device. For example, the broadcast signal receiving device may transmit the information upon detecting the presence of a user using a proximity sensor of the broadcast signal receiving device. The broadcast signal receiving device may transmit the information upon otherwise detecting the communication device in the absence of an express request. In one embodiment, the communication device includes an application or other program accessible from the user interface that enables the user to obtain information from the broadcast signal receiving device.

In some embodiments, the information transmitted to the communication device relates to programming currently viewed on or received by the broadcast signal receiving device. Exemplary information includes the program title, start time, duration, time remaining, cast, audience rating (e.g., G, PG-13, R, etc.), links to more information and other information related to the program. The information may also relate to future and past programming information. Other information, for example, the rating, time remaining, audio mode (e.g., stereo, mono, SAP), etc., about the program may also be obtained depending on the information made available (transmitted) by the broadcast signal receiving device. The information may include dial-in telephone number information associated with talk radio or infomercial programming, among other programming related information. Other information related to the program may be the identification of the station or frequency on which the program is broadcast, network and/or local affiliate identification or call sign information, broadcast format information (e.g., HDTV, NTSC).

In other embodiments where the broadcast signal receiving device transmits information for reception by one or more communication devices, the broadcast signal receiving device may transmit information related to the configuration or operation of the broadcast signal receiving device alone or in combination with other information, examples or which were discussed above. Exemplary information related to the broadcast signal receiving device includes audio configuration information (e.g., surround or non-surround sound audio mode), display aspect ratio information (e.g., standard, wide screen, etc.), volume settings (e.g., level, mute) among other information.

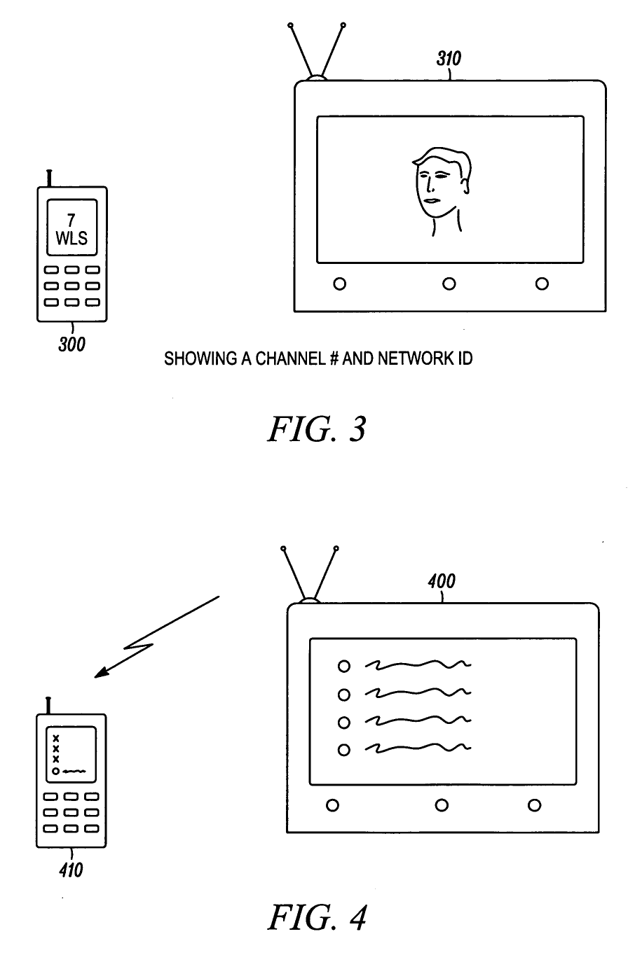

In FIG. 1, the communication device includes a user interface 230 on which information received from the broadcast signal receiving device may be presented to the user of the communication device. The user of the communication device is thus presented with information about the programming and configuration of the broadcast signal receiving device. The information may be presented audibly and/or visually. In FIG. 3, a communication device 300 displays the channel number and network identity for programming presented on a broadcast receiving device 310. In another scenario, a broadcast signal receiving device viewer tuning into an in-progress television or a radio program may readily determine what program is being viewed or listened to by using the communication device to receive programming information from the broadcast signal receiving device. The viewer may thus be apprised of a variety of programming related and configuration information of the broadcast signal receiving device using the communication device.

In another embodiment, the broadcast signal reception device transmits supplemental program information to the communication device wherein the supplemental information is related to the programming content presented on the broadcast signal reception device. In FIG. 4, the program on the broadcast signal receiving device 400 is a game show and the supplemental information sent to the communication device 411 includes answers to questions posed on the game show. Thus the user of the communication device can learn the correct answer without waiting for it to be announced over the broadcast signal receiving device. In another embodiment, the program is commercial or infomercial and the supplemental information is a link, e.g., a URL, to additional information or a telephone number to order product or obtain more information.

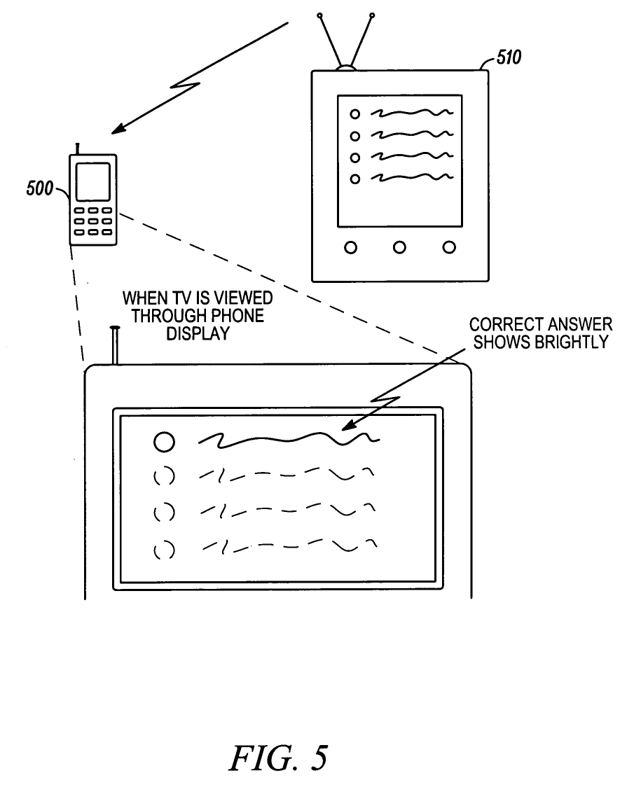

In another embodiment illustrated in FIG. 5, a communication device 500 modifies the viewing of what is on a television screen 510. Here, the communication device is configured so that it modulates transmitted light, either in intensity or color. For example, an LCD can be used in a manner as a shutter. The communication device receives control information from the broadcast device over the wireless link, or alternatively, from an analysis of the display itself perhaps for example, using a camera or an additional optical sensor as discussed further below. This embodiment uses the display on the personal device to provide detection of coded information on the TV that is embedded in the displayed picture. For example, a modulated (strobed) reception that is synchronized to the screen would be one implementation. Color separation is yet another means to accomplish this. For example, the television might show several alternative responses numbered 1, 2, 3, and 4. The different numbers are coded so that they are different colors. The color of the correct answer is sent to the device. The display is changed to provide a filter of the color of the correct answer. When a person looks through the transparent, tinted display, the correct answer will be apparent. The colors are changed randomly on each question.

In another embodiment, the communications device 200 includes an image and/or audio capture device 250 capable of capturing video image and/or audio information emitted by the broadcast signal receiving device. An exemplary image capture device is a camera engine capable of capturing still or video image information using a CCD array or other image capture technology. The capture device captures video or still image information presented on a display portion of the broadcast signal receiving device. The capture of image information from CRT and other display devices is known generally as discussed in U.S. Publication No. 2002/0171639 entitled “Methods And Apparatus For Transmitting Data Over Graphic Displays”. The capture device may also capture audio information emitted by a loudspeaker or a transducer of the broadcast signal receiving device. The information captured by the communication device is processed either at the communications device or at some other location, as discussed further below.

In embodiments where the communication device receives information from the broadcast signal receiving device via an image or audio capture device on the communication device, the information obtained from the broadcast signal receiving device is processed to interpret the information obtained. In one embodiment, for example, the processor 220 in FIG. 1 of the communication device processes captured video information displayed on the broadcast signal receiving device to obtain information related to the programming or the configuration of the broadcast signal receiving device.

The communication device may capture a variety of information presented on a display of a broadcast signal receiving device. In one embodiment, for example, the communication device captures programming image and/or audio information presented by the broadcast signal receiving device. In another embodiment, watermark information presented on the display of the broadcast signal receiving device is captured by the communication device. The watermark information may be the channel on which the programming is broadcast. In other embodiments, the broadcast signal receiving device may embed other information in the image for capture by the communication device. The communication device uses signature analyses and correlation processes to interpret the captured information. These processes may be implanted by a programmed digital processor, for example, the processor 220 of FIG. 2.

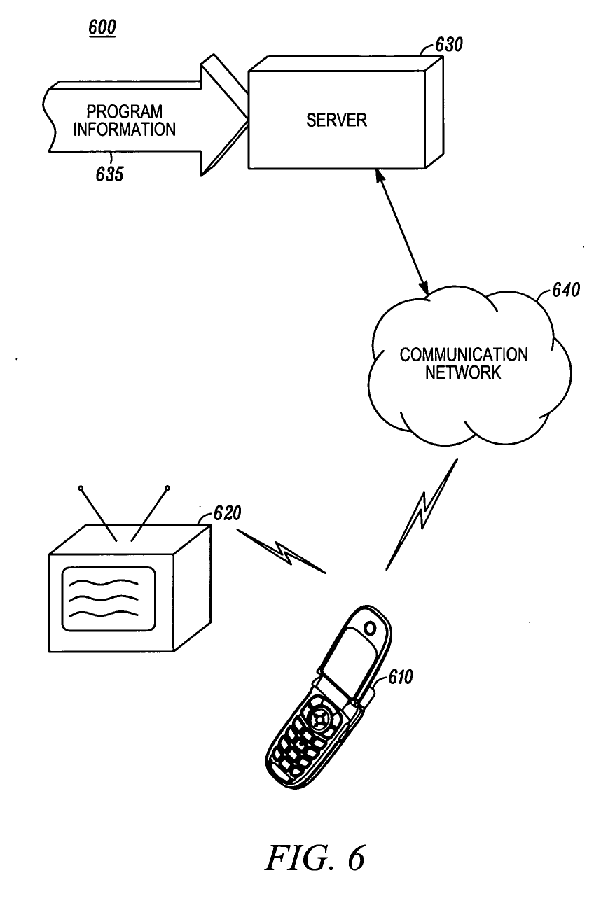

In another embodiment, the communication device transfers the captured audio and/or image information to a server, which processes the captured information. The server may also use a signature analysis and correlation processes, for example, based on know programming information, to interpret the information captured or received by the communication device. After processing, the server returns information related to the programming or the configuration of the broadcast signal receiving device to the communication device. In the exemplary communication system 600 of FIG. 6, a communication device 610 captures the audio and/or video information from a broadcast signal receiving device 620, and then transmits the captured information to a server 630 via a communication network 640. In embodiments where the communication device is a wireless communication device, the communication network 640 is a wireless communication network, for example, a cellular network. In embodiments where the communication device is a hardwired device, the network may be some other type of network. More generally, the network in FIG. 6 may be representative of more than one network. For example, the server may be accessible on the Internet by a communication device that communicates over a cellular network communicably coupled to the Internet by a gateway.

In one embodiment, the communication device transmits captured information to another entity, for example, the server 630 in FIG. 6, for interpretation. In one application, the communication device sends captured data to the server, which analyzes the data to determine the channel being viewed. The captured data may include for example a channel or network watermark that the server uses to identify the network. In FIG. 6, for example, the server 630 has access to programming and corresponding channel or local network information 635, which can be used to identify the programming based on the known channel or network identification, for example, by a correlation process. In another application, the communication device sends a captured program segment to the server, which analyzes to the program segment to identify the programming. Programming information accessible to the server can be used as a reference relative to which the captured program segment may be compared to identify the programming.

In some embodiments, the communication device identifies exactly what part of the broadcast channel is captured using time markers that are embedded in either the content or available from other sources, such as GPS. The time marker can be conveyed to the server, for example, server 610 in FIG. 6. The time marker makes it easier for the server to capture the section of information the communication device captured so that it can similarly be captured from the program information.

In some embodiments, at least some of the processing of the captured data occurs on the communication device. For example, the communication device may identify the channel or the network identification from captured watermark information.

As yet another aspect of this invention, I propose to put alternative download mechanisms into a subscriber device that can be reached by alternative media consistent with the described architecture. One embodiment would be to make it so that data can be downloaded to the subscriber device using the television. This information could be downloaded over the television screen by having the subscriber camera or some other port “look” at the screen during a show or a commercial. Alternatively, the wireless radio link could also be used. Cellular phones will have considerable opportunity to have data downloaded to them in the future. This mechanism could significantly reduce the cost by using some of the excess bandwidth and signaling channels that are available or a broadcast channel. While the home computer affords a much more efficient means to download information to users, all people do not have this capability nor is it always readily available. This invention could avoid unnecessary use of the scarce radio resources.

While the present disclosure and what are presently considered to be the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a mobile wireless communication device having a user interface, the method comprising:
receiving information from a proximal broadcast information receiving device;
providing information at the user interface of the mobile wireless communication device based on the information received from the broadcast information receiving device.

2. The method of claim 1,
providing information at the user interface of the mobile wireless communication device includes providing information related to broadcast information received by the broadcast information receiving device.

3. The method of claim 1,
providing information at the user interface of the mobile wireless communication device includes providing information that supplements broadcast related information provided at a user interface of the broadcast information receiving device.

4. The method of claim 1,
providing information at the user interface of the mobile wireless communication device includes providing information that is temporarily overlayed on a visual interface of the broadcast information receiving device.

5. The method of claim 1,
receiving information from the broadcast information receiving device includes capturing video information from the broadcast information receiving device with a video capture device of the mobile wireless communication device,
providing information at the user interface of the mobile wireless communication device based on the video information captured from the broadcast information receiving device.

6. The method of claim 1,
receiving information from the broadcast information receiving device includes capturing audio information from the broadcast information receiving device with an audio capture device of the mobile wireless communication device,
providing information at the user interface of the mobile wireless communication device based on the audio information captured from the broadcast information receiving device.

7. The method of claim 1,
receiving information from the broadcast information receiving device includes receiving a wireless radio signal emitted from the broadcast information receiving device,
providing information at the user interface of the mobile wireless communication device based on the wireless radio signal received from the broadcast information receiving device.

8. The method of claim 1,
providing the information at the user interface of the mobile wireless communication device includes presenting the information at one of an audio or visual interface of the mobile wireless communication device.

9. The method of claim 1,
sending information to a communication network entity based on the information received from the broadcast information receiving device,
receiving information from the communication network entity pertaining to the information received from the broadcast information receiving device,
the information provided at the user interface of the mobile wireless communication device is the information received from the communication network entity.

10. A mobile wireless communication device, comprising:
a processor;
a user interface coupled to the processor;
a broadcast information capture device coupled to the processor,
the user interface providing information based on broadcast information captured by the broadcast information capture device.

11. The device of claim 10, the broadcast information capture device is an image capture device.

12. The device of claim 10, the broadcast information capture device is an audio capture device.

13. The device of claim 10, the processor for extracting information from the broadcast information captured by the broadcast information capture device.

14. A portable wireless communication device having a user interface, comprising:
a programming information receiving device capable of receiving programming information from a proximal broadcast information receiving device;
a processor programmed to identify the programming information received from the proximal broadcast information receiving device.

15. The portable device of claim 14,
the programming information receiving device capable of receiving video programming information from a proximal broadcast information receiving device,
the processor programmed to identify the video programming information received from the proximal broadcast information receiving device.

16. The portable device of claim 14,
the processor programmed to identify the programming information received from the proximal broadcast information receiving device based on a correlation analysis.
